(19) United States
(12) Patent Application Publication
(10) Pub. No.: US 2015/0215530 A1
(43) Pub. Date: Jul. 30, 2015

(54) UNIVERSAL CAPTURE

(71) Applicant: MICROSOFT CORPORATION, Redmond, WA (US)

(72) Inventors: Donald A. Barnett, Monroe, WA (US); Daniel Dole, Seattle, WA (US)

(73) Assignee: MICROSOFT CORPORATION, Redmond, WA (US)

(21) Appl. No.: 14/165,442

(22) Filed: Jan. 27, 2014

(51) Int. Cl. H04N 5/232

(52) U.S. Cl. CPC H04N 5/23229; H04N 5/23216; H04N 5/23222; H04N 5/23245; H04N 5/23293

(57) ABSTRACT

Architecture that enables the automatic capture and save images of objects and scenes in multiple media formats such as images, videos, and 3D (three-dimension). The user can shoot now and decide the medium later. Thereafter, the user can choose which format to review and perform editing, if desired. Moreover, once the user interacts to cause the imaging system to activate (a capture signal), the architecture continually captures images of the object or scene until the user sends a save signal to terminate further capture. Thus, where there may have been a bad shot taken, the user can peruse the set of images for a preferred shot, rather than being left with no good shot at all. The architecture enables the capture of images for a predetermined time before the user activates the capture signal (a pre-capture mode) as well as after the user activates the save signal (a post-save mode).

### BACKGROUND

Image capture subsystems are in nearly every portable handheld computing device and are now considered by users as an essential source of enjoyment. However, existing implementations have significant drawbacks as with current image capture devices such as cameras—the user can take a photograph, but then upon review, realize the perfect shot was missed; have taken a photo, but then realized too late that a video would have been preferred; and wished for the capability to manipulate a captured object to get a better angle. This is a highly competitive area as consumers are looking for more sophisticated options for an enhanced media experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a user to automatically capture and save images of objects and scenes in multiple media formats such as images, videos, and 3D (three-dimension). The user is provided with the capability to shoot now and decide the medium later. Each instance of capture is automatically saved and formatted into the three types of media. Thereafter, the user can then choose which format to review, and perform editing, if desired. Moreover, once the user interacts to cause the imaging system to activate (a capture signal), the architecture continually captures images of the object or scene until the user sends a save signal to terminate further capture. Thus, where there may have been a bad shot taken, the user can peruse the set of images for a preferred shot, rather than being left with no good shot at all.

In an alternative embodiment, the architecture enables the capture of images for a predetermined time before the user activates the capture signal (a pre-capture capability or mode) as well as after the user activates the save signal (a post-save capability or mode). In this case as well, formatting can be automatically in the multiple different formats. Audio can be captured as well for each of the different media formats.

The architecture comprises a user interface that enables the user to start capturing with a single gesture. A hold-to-capture gesture captures the object/scene in at least the three different media formats. The architecture can also automatically select the optimum default output.

Technologies are provided that enables the capture of images before the user “presses the shutter” and continues to capture pictures after the user has taken the shot. The preferred shot among the many captured can then be shared with other users. Yet another technology enables the user to take a series of images (e.g., consecutive) and then turn these images into an interactive 3D geometry. While video enables the user to edit an object in time, this technology enables the user to edit an object in space, regardless of the order in which the images were taken.

Put another way, instances of image sensor content are generated continually in the camera in response to a capture signal. The instances of the image sensor content are stored in the camera in response to receipt of a save signal. The instances of image sensor content are formatted in the camera and in different media formats. Viewing of the instances of image sensor content is enabled in the different formats. The capture signal can be detected as a single intended (not accidental) and sustained user gesture (e.g., a sustained touch or pressure contact, hand gesture, etc.) to enable the camera to continually generate the image sensor content. The method can further comprise automatically selecting one of the different formats as a default output for user viewing absent user configuration to set the default output. Additionally, the storage and format of an instance of the image sensor content is enabled prior in time to the receipt of the capture signal and after the save signal.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a flow diagram of one implementation of the disclosed architecture.

FIG. 3 illustrates a flow diagram of user interaction universal capture using multiple formats.

FIG. 4 illustrates an exemplary user interface that enables review of the captured and saved content.

FIG. 5 illustrates a method of processing image sensor content in a camera in accordance with the disclosed architecture.

FIG. 6 illustrates an alternative method in accordance with the disclosed architecture.

FIG. 7 illustrates a handheld device that can incorporate the disclosed architecture.

FIG. 8 illustrates a block diagram of a computing system that executes universal capture in accordance with the disclosed architecture.

### DETAILED DESCRIPTION

The disclosed architecture enables a user to automatically capture and save images of objects and scenes in multiple media formats such as images, videos, and 3D (three-dimension). The user is provided with the capability to shoot now and decide the medium later. Each instance of capture is automatically saved and formatted into the three types of media. Thereafter, the user can then choose which format to review, and perform editing, if desired. Moreover, once the user interacts to cause the imaging system to activate (a capture signal), the architecture continually captures images of the object or scene until the user sends a save signal to terminate further capture. Thus, where there may have been a bad shot taken, the user can peruse the set of images for a preferred shot, rather than being left with no good shot at all.

In an alternative embodiment, the architecture enables the capture of images for a predetermined time before the user activates the capture signal (a pre-capture capability or mode) as well as after the user activates the save signal (a post-save capability or mode). In this case as well, formatting can be automatically in the multiple different formats. Audio can be captured as well for each of the different media formats.

The architecture comprises a user interface that enables the user to start capturing with a single gesture. A hold-to-capture gesture captures the object/scene in at least the three different media formats. The architecture can also automatically select the optimum default output.

Technologies are provided that enables the capture of images before the user “presses the shutter” and continues to capture pictures after the user has taken the shot. The preferred shot among the many captured can then be shared with other users. Yet another technology enables the user to take a series of images (e.g., consecutive) and then turn these images into an interactive 3D geometry. While video enables the user to edit an object in time, this technology enables the user to edit an object in space, regardless of the order in which the images were taken.

The user may interact with the device by way of gestures. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

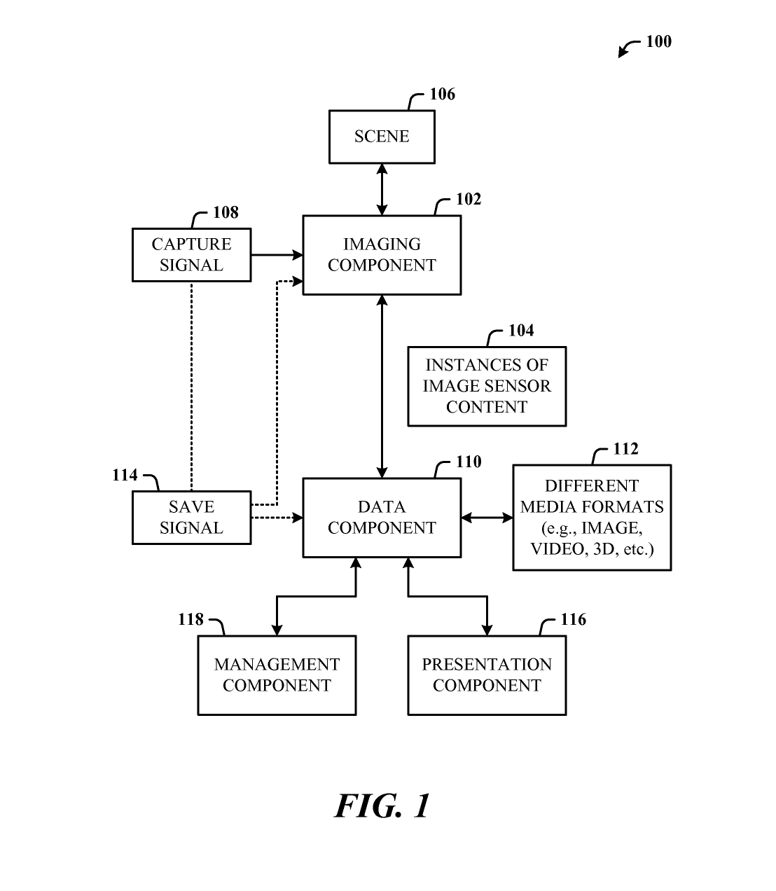

FIG. 1 illustrates a system 100 in accordance with the disclosed architecture. The system 100 can include an imaging component 102 of a device (e.g., a camera, cell phone, portable computer, tablet, etc.) can be configured to continually generate instances (e.g., images, frames, etc.) of image sensor content 104 of a scene 106 (e.g., person, thing, view, etc.) in response to a capture signal 108. The content is what is captured of the scene 106.

The imaging component 102 can comprise hardware such as the image sensor (e.g., CCD (charge coupled device), CMOS (complementary metal oxide semiconductor), etc.) and software for operating the image sensor to capture the images of the scene 106 and process the content input to the sensor to output the instances of the sensor image content 104.

A data component 110 of the device can be configured to format the instances of image sensor content 104 in different media formats 112 in response to receipt of a save signal 114. The data component 110 can comprise the software that converts the instances of image sensor content to the different media formats 112 (e.g., mp3 for images, mp4 for videos, etc.).

The save signal 114 can be implemented in different ways, as indicated by the dotted lines. The save signal 114 can be input to the imaging component 102 and/or the data component 110. If input to the imaging component 102, the image component 102 communicates the save signal 114 to the data component 110 to then format and store (or store and format) the instances of image sensor content 104) into the different media formats 112.

The save signal 114 can also be associated with a state of the capture signal 108. For example, if mechanically implemented, a sustained press of a switch (a capture state) initiates capture of the scene 106 in several of the instances of the sensor image content 104. Release of the sustained press (a save state) on the same switch is then detected to be the save signal 114.

Where the capture signal 108 and save signal 114 are implemented in software and used in cooperation with a touch display, the capture signal 108 can be an single contacting touch to a designated capture spot on the display, and the save signal 114 can be a single contacting touch to a designated save spot on the display.

The mechanical switch behavior (press for capture and release for save) can also be characterized in software. For example, a sustained touch on a spot of the display can be interpreted to be the capture signal 108 and release of the sustained touch on that spot can be interpreted to be the save signal 114. As previously indicated, non-contact gestures (e.g., the NUI) can also be employed where desired such that the device camera and/or microphone interprets air gestures and/or voice commands to effect the same capabilities described herein.

A presentation component 116 of the device can be configured to enable interactive viewing of the instances of image sensor content 104 in the different formats 112. The data component 110 and/or the presentation component 116 can utilize one or more technologies that provide the video and 3D outputs for presentation. For example, one technology provides a way to capture, create, and share short dynamic media. In other words, a burst of images is captured before the user “presses the shutter” (the save signal 114), and continues to capture pictures after the user has initiated the save signal 114. The user is then enabled to save and share the best shot (e.g., image, series of images, video, with audio, etc.) as selected by the user and/or determined by device algorithms.

Another technology enables the capture of a series (e.g., consecutive) of photographs and converts this series of photographs into an interactive 3D geometry. While typical video enables the user to scrub (modify, cleanup) an object in time, this additional technology enables the user to scrub an object in space, no matter what order the shots (instances or images) were taken.

The data component 110, among other possible functions, formats an instance of image sensor content (of the instances of image sensor content 112) as an image, a video, and/or a three-dimensional media. The presentation component 116 enables the instances of content 112 to be scrolled and played according to the various media formats. For example, as a series of images, the user is provided the capability to peruse the images individually and impose typical media editing operations such as edit or remove certain instances, change color, remove “red eye”, etc., as desired. In other words, the user is provided the capability to move forward and backward in time to view the several instances of image sensor content 112.

The data component 110 comprises an algorithm that converts consecutive instances of images into an interactive three-dimensional geometry. This includes, but is not limited to, providing perspective to consecutive instances such that the user views the instances as if walking past the scene on the left or the right, while also showing a forward view.

The data component 110 comprises an algorithm that enables recording of instances of image sensor content before activation of the capture signal 108 and after activation of the save signal 114. In this case, the user can manually initiate (by gesture) this capability before interacting to send either of the capture signal 108 or the save signal 114. The system 100 then begins operating similar to a circular buffer where a certain amount of memory can be utilized to continually receive and generate instances of the scene 106, and once exceeded, begins to overwrite the previous data in the memory. Once the capture signal 108 is sent, the memory stores the instances before receipt of the capture signal 108 and any instances from receipt of the capture signal 108 to receipt of the save signal 114. The capability “locks in” content (images, audio, etc.) of the scene 106 prior to activation of the capture signal 108.

It can be the case that a user or device configuration is to capture and save scene content a predetermined amount of time after receipt of the save signal 114. Thus, the system 100 provides pre-capture instances of content and post-save instances of content. The user is then enabled to peruse this content as well, in the many different media formats, and edit as desired to provide the desired output.

The system 100 can further comprise a management component 118 can be software configured to enable automatic selection and/or user selection of an optimum output for a given scene and time. The management component 118 can also be configured to interact with the data component 110 and/or imaging component 102 to enable the user to make settings for pre-capture operations (e.g., time duration, frame or image counts, etc.), settings for post-save operations (e.g., time duration, frame or images counts, etc.), and so on.

The presentation component 116 enables review of the formatted instances of content 112 in each of the different formats. The imaging component 102 continually records the image sensor content in response to a sustained user action and ceases recording of the image sensor content in response to termination of the user action. This can be implemented mechanically and/or purely via software.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remote service.

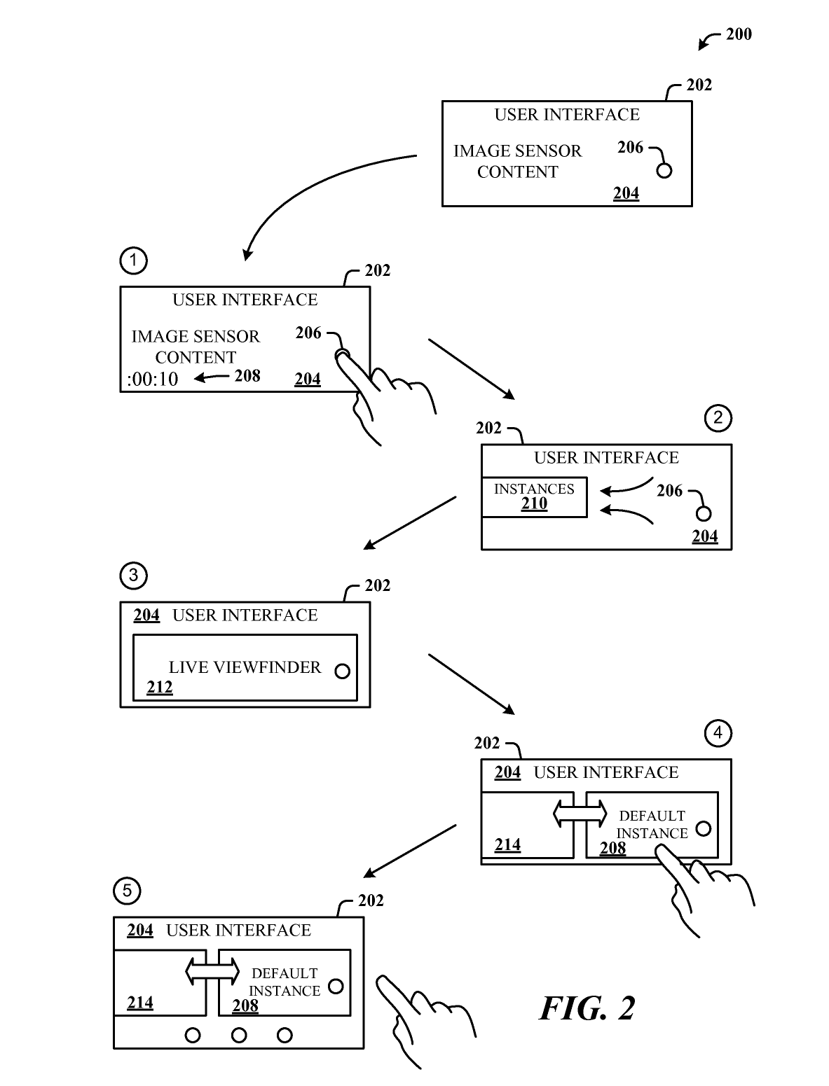

FIG. 2 illustrates a flow diagram 200 of one implementation of the disclosed architecture. This example is described using a handheld device 202 where user interaction with the touch user interface 204 involves a right index finger. However, it is to be understood that any gesture (e.g., tactile, air, voice, etc.) can be utilized where suitably designed into the operation of the device. Here, the touch user interface 204 presents a spot 206 (an interactive display control) on the display that the user touches. A sustained contact or touch pressure initiates the capture signal. Alternatively, but not limited thereto, momentary tactile contacts (touch taps) or long holds (sustained tactile contact) work as well.

At \textcircled{1}, a user is holding the handheld device 202 and interacting with the device 202 via the spot 206 on the user interface 204. The user interaction includes touching (using the index or pointing finger) the touch-sensitive device display (the user interface 204) at the spot 206 designated to initiate capture of the instances of image sensor content, as received into the device imaging subsystem (e.g., the system 100). While sustaining tactile pressure on the display spot 206, the capture signal is initiated, and a timer 208 is displayed in the user interface 204 and begins incrementing to indicate to the user the duration of the sustained press or the capture action. When the user ceases the touch pressure, this then also indicates the length of the content captured and saved.

At \textcircled{2}, when the user ceases touch interaction (i.e., lifts the finger from contact with the display), the user interface 204 animates the view by presenting a “lift” animation (reduces the dimensional size of the content in the user interface view) and which also animates moving the reduced content (instances) leftward off the display. The lift animation can also indicate to the user that the save signal has been received by the device. The saved content (instances 210) may be partially presented on the left side of the display, indicating to the user a grab point to later pull the content rightward for review.

At \textcircled{3}, since the save signal has been detected, the device automatically returns to a live viewfinder 212 where the user can see the realtime images of the actual scene as the device imager receives and processes the scene.

Alternatively, at \textcircled{3}, the device imaging subsystem automatically presents a default instance in the user interface 204. The default instance can be manually configured via the management component 118 to always present a single image of a series of images. Alternatively, the imaging subsystem automatically chooses which media format to show as the default instance. Note that as used herein, the term “instance” can mean a single image, multiple images, a video media format comprising multiple images, and the 3D geometric output.

At \textcircled{4}, the user interacts with the partial saved content or some control suitably design to indicate to the user that the user can interact to pull the saved content into view for further observation. From this state, the user can navigate left or right (e.g., using a touch and drag action) to view other instances in the “roll” of pictures, such as a second instance 214 captured during the same image capture session or a different session.

At \textcircled{5}, before, during, or after the review process, the user can select the type of already-formatted content in which to view the captured content (instances).

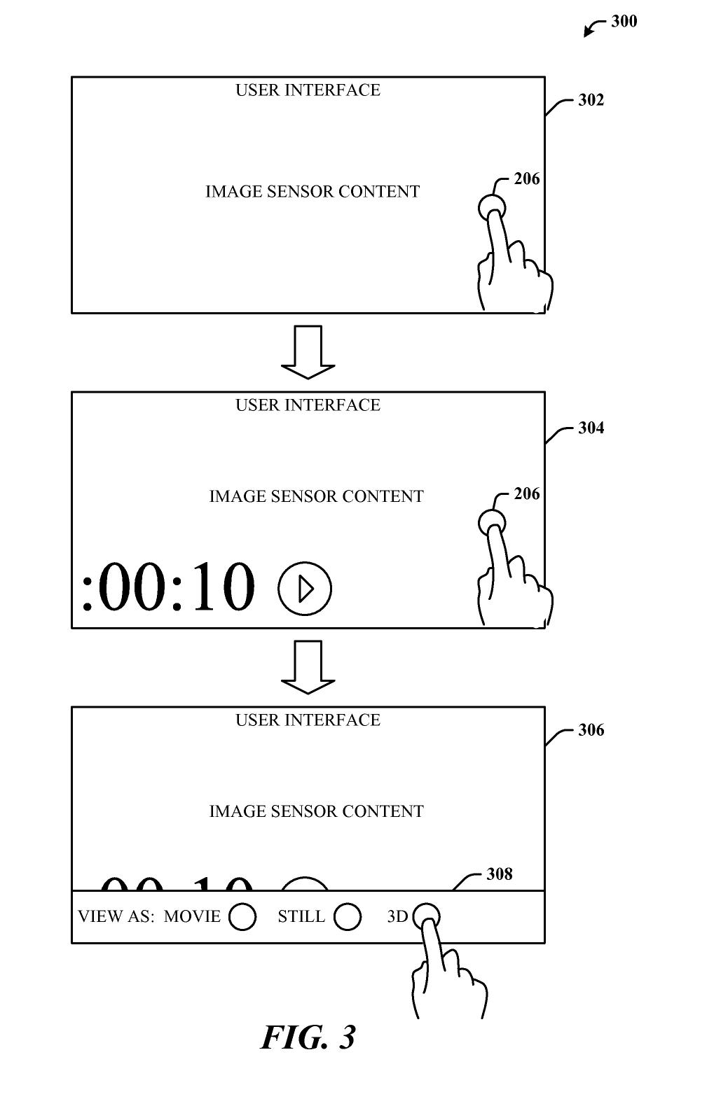

FIG. 3 illustrates a flow diagram 300 of user interaction universal capture using multiple formats. At 302, the user interacts via touch with an interactive control (the spot 206). At 304, if the user sustains the touch on the spot 206, a timer is made to appear so the user can see the duration the capture mode. At 306, once the user terminates the touch action on the spot 206, the save signal is detected, and a media format block 308 can be made to appear in the user interface such that the user can select one of many formats to view the captured content. Here, the user selects the interactive 3D format for viewing.

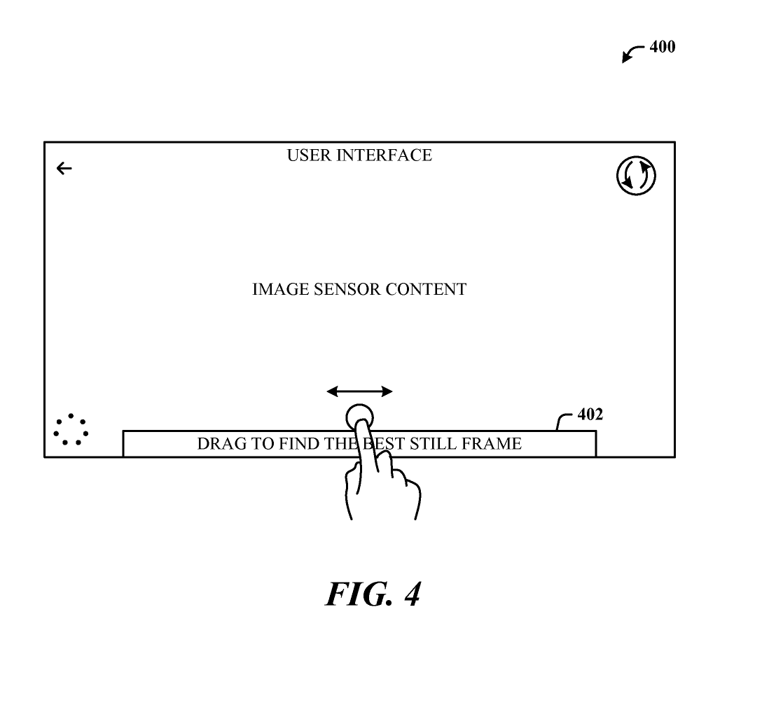

FIG. 4 illustrates an exemplary user interface 400 that enables review of the captured and saved content. In this example embodiment, a slider control 402 is presented for user interaction that corresponds to images captured and saved. The user can utilize the slide control 402 to review frames (individual images in any of the media formats.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

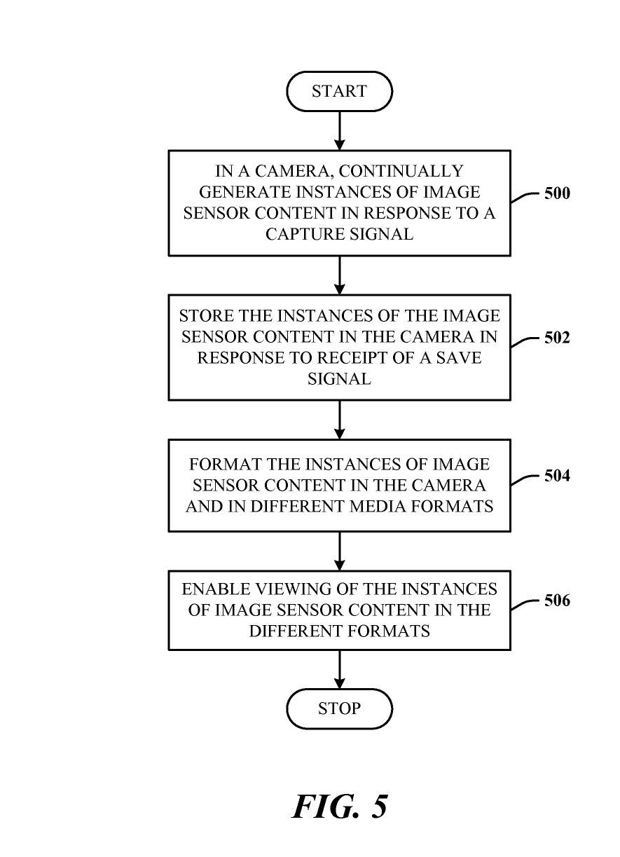

FIG. 5 illustrates a method of processing image sensor content in a camera in accordance with the disclosed architecture. At 500, instances of image sensor content are generated continually in the camera in response to a capture signal. At 502, the instances of the image sensor content are stored in the camera in response to receipt of a save signal. At 504, the instances of image sensor content are formatted in the camera and in different media formats. At 506, viewing of the instances of image sensor content is enabled in the different formats.

The method can further comprise detecting the capture signal as an intended (not accidental) and sustained user gesture (e.g., a sustained touch or pressure contact, hand gesture, etc.) to enable the camera to continually generate the image sensor content. The method can further comprise formatting the instance of image sensor content as one or more of an image format, a video format, and a three-dimensional format. The method can further comprise automatically selecting one of the different formats as a default output for user viewing absent user configuration to set the default output.

The method can further comprise initiating the capture signal using a single gesture. The method can further comprise enabling storage and formatting of an instance of the image sensor content prior in time to the receipt of the capture signal. The method can further comprise formatting the instances of the image sensor content as an interactive three-dimensional geometry.

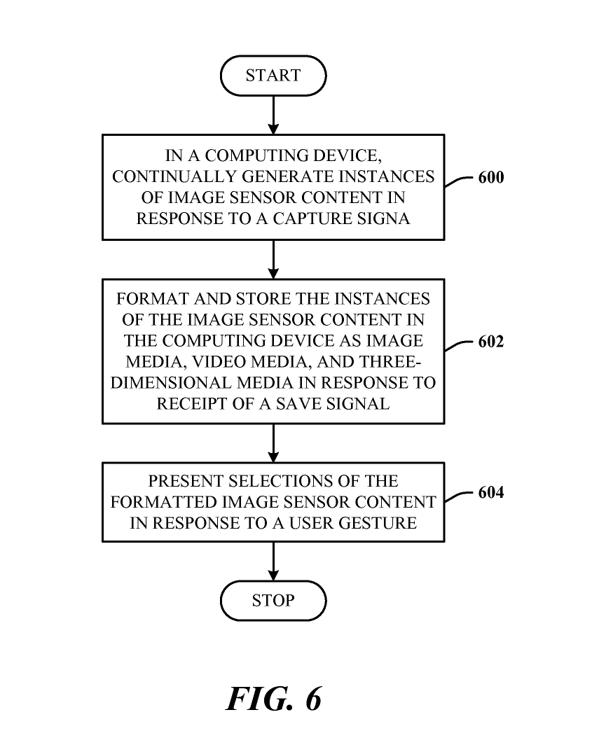

FIG. 6 illustrates an alternative method in accordance with the disclosed architecture. The method can be embodied as computer-executable instructions on a computer-readable storage medium that when executed by a microprocessor, cause the microprocessor to perform the following acts. At 600, in a computing device, instances of image sensor content are generated continually in response to a capture signal. At 602, the instances of the image sensor content are formatted and stored in the computing device as image media, video media, and three-dimensional media in response to receipt of a save signal. At 604, selections of the formatted image sensor content are presented in response to a user gesture.

The method can further comprise automatically selecting one of the different formats as a default output for user viewing absent user configuration to set the default output. The method can further comprise initiating the save signal using a single user gesture. The method can further comprise enabling storage and formatting of an instance of the image sensor content prior in time to the receipt of the capture signal and after the save signal. The method can further comprise formatting the instances of the image sensor content as an interactive three-dimensional geometry.

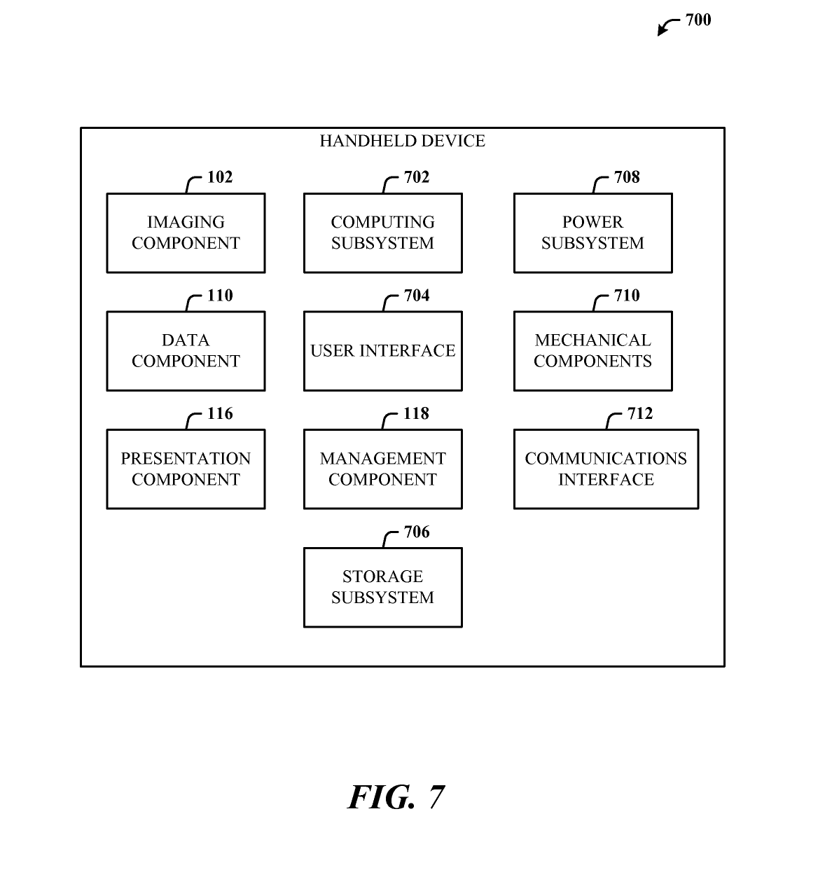

FIG. 7 illustrates a handheld device 700 that can incorporate the disclosed architecture. The device 700 can be a smart phone, camera, or other suitable device. The device 700 can include the imaging component 102, the data component 110, presentation component 116, and management component 118.

A computing subsystem 702 can comprise the processor(s) and associated chips for processing the received content generated by the imaging component. The computing subsystem 702 executes the operating system of the device 700, and any other code needed for experiencing full functionality of the device 700, such as gesture recognition software for NUI gestures, for example. The computing subsystem 702 also executes the software that enables at least the universal capture features of the disclosed architecture as well as interactions of the user to the device and/or display. A user interface 704 enables the user gesture interactions. A storage subsystem 706 can comprise the memory for storing the captured content. The power subsystem 708 provides power to the device 700 for the exercise of all functions and code execution. The mechanical components 710 comprise, for example, any mechanical buttons such as power on/off, shutter control, power connections, zoom in/out, and other buttons that enable the user to affect settings provided by the device 700. The communications interface 712 provides connectivity such as USB, short range communications technology, microphone for audio input, speaker output for use during playback, and so on.

It is to be understood that in the disclosed architecture as implemented in the handheld device 700, for example, certain components may be rearranged, combined, omitted, and additional components may be included. Additionally, in some embodiments, all or some of the components are present on the client, while in other embodiments some components may reside on a server or are provided by a local or remote service.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

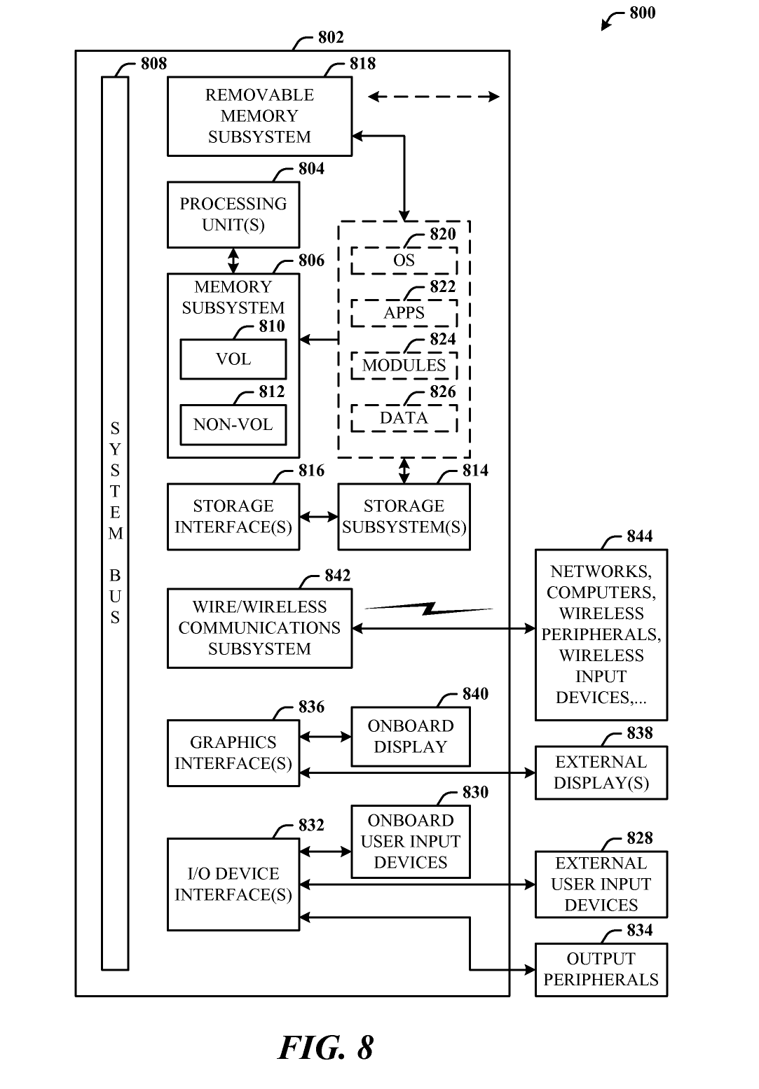

Referring now to FIG. 8, there is illustrated a block diagram of a computing system 800 that executes universal capture in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having microprocessing unit(s) 804 (also referred to as microprocessor(s) and processor(s)), a computer-readable storage medium such as a system memory 806 (computer readable storage medium/media also include magnetic disks, optical disks, solid state drives, external memory systems, and flash memory drives), and a system bus 808. The microprocessing unit(s) 804 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the microprocessing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components and circuits. The storage subsystem(s) 814 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include items and components of the system 100 of FIG. 1, items and components of the flow diagram 200 of FIG. 2, items and flow of the diagram 300 of FIG. 3, the user interface 400 of FIG. 4, and the methods represented by the flowcharts of FIGS. 5 and 6, for example.

Generally, programs include routines, methods, data structures, other software components, etc., that perform particular tasks, functions, or implement particular abstract data types. All or portions of the operating system 820, applications 822, modules 824, and/or data 826 can also be cached in memory such as the volatile memory 810 and/or non-volatile memory, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 802, programs, and data using onboard user input devices 830 such a touchpad, microphone, keyboard, etc., where the computer 802 is a portable computer, for example.

These and other input devices are connected to the microprocessing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an imaging component of a device configured to continually generate instances of image sensor content in response to a capture signal;
a data component of the device configured to format the instances of image sensor content in different media formats in response to receipt of a save signal;
a presentation component of the device configured to enable interactive viewing of the instances of image sensor content in the different formats; and
at least one microprocessor of the device configured to execute computer-executable instructions in a memory associated with the image component, data component, and the presentation component.

2. The system of claim 1, wherein the data component formats an instance of image sensor content as an image, a video, and a three-dimensional media.

3. The system of claim 1, wherein the presentation component enables the instances of content to be scrolled and played.

4. The system of claim 1, further comprising a management component configured to enable automatic selection of an optimum output for a given scene.

5. The system of claim 1, wherein the data component comprises an algorithm that converts consecutive instances of images into an interactive three-dimensional geometry.

6. The system of claim 1, wherein the data component comprises an algorithm that enables recording of the instances of images before activation of the capture signal and after activation of the save signal.

7. The system of claim 1, wherein the presentation component enables review of the formatted instances of content in each of the different formats.

8. The system of claim 1, wherein the imaging component continually records the image sensor content in response to a sustained user action and ceases recording of the image sensor content in response to termination of the user action.

9. A method of processing image sensor content in a camera, comprising acts of:
in a camera, continually generating instances of image sensor content in response to a capture signal;
storing the instances of the image sensor content in the camera in response to receipt of a save signal;
formatting the instances of image sensor content in the camera and in different media formats;
enabling viewing of the instances of image sensor content in the different formats; and
configuring a microprocessor circuit to execute instructions in a memory related to the acts of generating, storing, formatting, and enabling.

10. The method of claim 9, further comprising detecting the capture signal as an intended and sustained user gesture to enable the camera to continually generate the image sensor content.

11. The method of claim 9, further comprising formatting the instance of image sensor content as one or more of an image format, a video format, and a three-dimensional format.

12. The method of claim 9, further comprising automatically selecting one of the different formats as a default output for user viewing absent user configuration to set the default output.

13. The method of claim 9, further comprising initiating the capture signal using a single gesture.

14. The method of claim 9, further comprising enabling storage and formatting of an instance of the image sensor content prior in time to the receipt of the capture signal.

15. The method of claim 9, further comprising formatting the instances of the image sensor content as an interactive three-dimensional geometry.

16. A computer-readable storage medium comprising computer-executable instructions that when executed by a microprocessor, cause the microprocessor to perform acts of:
in a computing device, continually generating instances of image sensor content in response to a capture signal;
formatting and storing the instances of the image sensor content in the computing device as image media, video media, and three-dimensional media in response to receipt of a save signal; and
presenting selections of the formatted image sensor content in response to a user gesture.

17. The computer-readable storage medium of claim 16, further comprising automatically selecting one of the different formats as a default output for user viewing absent user configuration to set the default output.

18. The computer-readable storage medium of claim 16, further comprising initiating the save signal using a single user gesture.

19. The computer-readable storage medium of claim 16, further comprising enabling storage and formatting of an instance of the image sensor content prior in time to the receipt of the capture signal and after the save signal.

20. The computer-readable storage medium of claim 16, further comprising formatting the instances of the image sensor content as an interactive three-dimensional geometry.
